(19) United States
(12) Patent Application Publication
(10) Pub. No.: US 2006/0201278 A1
(43) Pub. Date: Sep. 14, 2006

(54) High power density speed reducer drive system and method

(76) Inventors: William P. Pizzichil, Easley, SC (US); Stephen Thomas Evon, Easley, SC (US); Chuong H. Nguyen, Simpsonville, SC (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 11/079,581

(22) Filed: Mar. 14, 2005

(51) Int. Cl. F16H 35/00

(52) U.S. Cl. 74/640

(57) ABSTRACT

A novel mechanical drive system is disclosed in which a high-speed motor is directly mounted to a gear reducer and drive at high speeds by a variable high speed drive. The high-speed motor has significantly reduced envelope dimensions and consequent mass due to its high-speed operating capabilities, without reducing the rated power of the drive system. The drive assembly can be mounted on a machine or as an overhung load with reduced stress on the machine frame or a driven shaft due to the lower mass and weight of the drive assembly, owing a large part to the reduced mass of the high-speed motor. The drive circuitry is designed to provide a sinusoidal input to the high-speed motor based upon a control input, which may include closed-loop control with parameters of the driven load or a process in which the load is part.

### BACKGROUND

The present invention relates generally to speed reducers and similar power transmission devices used in industrial and other applications. More particularly, the invention relates to a novel speed reducer and drive combination employing a high-speed motor input to form a high power density system, and significantly reduce the mass and consequent mechanical load on the machine frame.

Speed reduces are known and used in a wide range of industrial applications. Generally, such equipment facilitates driving loads, such as conveyers, at appropriate speeds while enabling a prime mover, typically an electric motor, to be driven at higher speeds. Different overall arrangements have been employed for this type of speed reduction and consequent torque multiplication. Industrial applications have and still presently use belt drives, chain drives, gear reducers, and so forth for reducing input speeds to desired output speeds.

Where speeds are to be varied, conventional equipment becomes more complex. For example, where significant variations in speed are desired, typically with step changes, transmissions may be employed. Such transmissions require shifting and control, however, and are not always appropriate or convenient. Transmissions also require significant outlays both in initial cost and in maintenance. Belt drives have been designed that permit speed reduction and some degree of variability in output speeds. Such belt drives are useful in many applications, but are subject to other drawbacks. For example, belt drives can be made variable in output speed, but at the cost of somewhat sensitive mechanical arrangements. Moreover, belts are inherently subject to wear and replacement, and occupy a substantial space for mounting of the prime mover and sheaves or other mechanical components on which the belts ride. Belt drives are also typically shielded to prevent object from becoming entangled in the belts, further adding to cost and space.

Gear reducers are also common for such applications. Conventional gear reducers generally include input gearing and one or more stages of gear reduction to produce a desired output speed. If the input motor speed is varied, the output speed can be similarly varied. Gear reducers have also been designed as “gearmotors” in which a motor is solidly attached to a gear reducer frame. The entire gear reducer can be mounted on a driven machine or even suspended from a driven shaft. In both mounting arrangements, however, gearmotors represent a very significant load on the machine frame or the driven shaft. In many applications, the load is presented as an overhung load which adds to the complexity, size and cost of the supporting machine frame, bearings, shafts, and so forth. Thus, even with gearmotors as one option, design engineers may select belt drives for certain applications, even with their drawbacks, to avoid the weight and loads implied by the mass of conventional gearmotors.

There is a need in the art for improved techniques for providing speed reduction and variable speed while reducing the mass and consequent weight of the overall drive system. There is a particular need for a high power density system capable of delivering high torques and speeds in a smaller and lighter package.

### BRIEF DESCRIPTION

The present invention provides a novel system-level arrangement to address such needs. The system makes use of a high-speed electric motor driven by a variable frequency motor drive. The high-speed motor can output power at a range of speeds depending upon the input drive signals. The high-speed motor is fixed to a gear reducer frame and drives the gear reducer to power a downstream load. While in certain contexts the motors employed in the present techniques may be considered “medium speed,” for the gear reducer power transmission devices envisaged, the continuous operating speeds of the electric motor represent significant increases, and are thus termed “high speed.”

Due to the high-speed design of the motor, its power rating is significantly increased as compared to other motors used in convention arrangements. Otherwise put, the motor and resulting drive package can maintain an output power rating while significantly reducing the mass, volume and weight. Thus, the loading placed on machine frames, bearings, shafts and so forth is significantly reduced, while providing the desired reduced output speed and speed variability.

The invention enables a range of application to be significantly redesigned and improved. Such applications might include screw conveyers, belt conveyers, mixers, agitators, and a whole host of other industrial, commercial and general purpose applications.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a power transmission system in accordance with aspects of the present technique;

FIG. 2 is a front perspective view of an exemplary drive assembly in accordance with the present technique, of the type that may be employed in the system of FIG. 1;

FIG. 3 is a rear perspective view of the drive assembly of FIG. 2; and

FIG. 4 is a partial sectional view of the drive assembly of the preceding figures illustrating an exemplary construction for the high-speed motor directly driving the internal gearing of the gear reducer.

### DETAILED DESCRIPTION

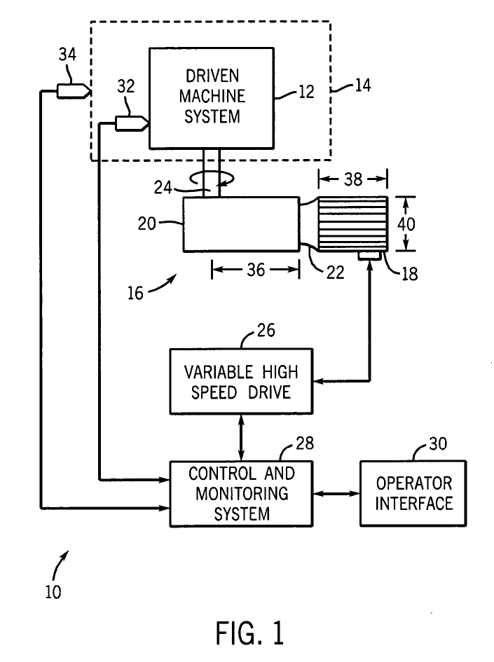

Turning now to the drawings, and referring first to FIG. 1, a power transmission system 10 is illustrated diagrammatically as including a driven machine system 12 that may be thought of as part of an overall machine process 14. The driven machine system 12 may include any suitable application or load, such as a screw conveyer, belt conveyer, mixer, agitator, or any other driven machine. In general, the driven machine system 12 requires a rotational drive at a rotational speed lower than the synchronous or continuous operating speed of an input device or motor. Moreover, the driven machine system 12 requires variable speeds. The process 14 may include any material transformation process in which the driven machine system 12 is installed. In general, the driven machine system 12 will move a load which is at least partially based upon the requirements of the process 14. Depending upon the application, such loads may include fungible materials, articles of manufacture, work pieces, ore and minerals, and so forth.

The driven machine system 12 is coupled to a drive assembly 16. The drive assembly 16, in the illustrated embodiment, takes the form of a gearmotor that includes a high-speed motor 18 coupled to a gear reducer 20. As described in greater detail below, the high-speed motor 18 is designed to operate at speeds significantly higher than the synchronous speed of a two-pole machine driven at the conventional grid frequency of 60 Hz. That is, as used herein, the term “high-speed” relating to motor 18 implies that the motor can be and is driven by the drive circuitry described below at greater than 3600 RPM for extended periods during normal operation.

In a current implementation, for example, the motor 18 is a totally-enclosed, fan-cooled machine built on a standard NEMA 140 frame. This four-pole machine has a synchronous speed of 1800 RPM at 60 Hz, and would normally be rated at 2 Hp. However, as described below, the motor is driven, in the present embodiment, at significantly higher frequencies of at least approximately 180 Hz, resulting in a maximum speed of at least approximately 5400 RPM. This, then, is the input speed to the gear reducer 20. It is believed that the resulting power rating of the motor can be increased from 2 Hp to approximately 10 Hp. The frequency of drive signals provided to the motor may be regulated to provide torque and speed control, and to drive the gear reducer at significantly lower speeds.

Gear reducer 20 is described in greater detail below. In general, however, any suitable gear reducer design may be employed. In a current implementation described herein, the gear reducer includes a bevel gear input stage followed by a series of spur gear reduction stages. Moreover, the gear reducer 20 is specially designed to provide a direct coupling 22 for mounting the high-speed motor. Output from the gear reducer to the driven machine system 12 is accomplished via a driven shaft 24. As described in greater detail below, the output from the gear reducer could be in the form of a female hub, such that the machine could be mounted directly on the driven output shaft as an overhung load.

The high-speed motor 18 is driven by a variable high-speed drive 26. In a present implementation, the high-speed drive includes an inverter drive having a three-phase inverter bridge which is switched at appropriate intervals to present a pulse width modulated sinusoidal input to the high-speed motor 18, the frequency of which can be modulated to cause the high-speed motor to rotate at various speeds. The variable high-speed drive 26 is particularly adapted to cause the motor to rotate at speeds in excess of 3600 RPM; the synchronous speed of a two-pole machine driven at 60 Hz. However, the drive 26 can cause rotation of the motor 18 at reduced speeds, including speeds lower than 3600 RPM. As mentioned above, in a present implementation, the drive 26 can apply control signals (power) to the motor at a frequency of 180 Hz and beyond, allowing a 4-pole machine to be driven at speeds of at least approximately 5400 RPM.

The variable high-speed drive 26 is controlled via a control and monitoring system, designated generally by reference numeral 28. The control and monitoring system 28 may include a simple operator interface as indicated at reference numeral 30, and is adapted to generate control signals that are applied to the drive 26 to cause the drive to output control signals (i.e., sinusoidal input power) to drive the motor at the desired speeds. Control and monitoring system 28 may be a part of an overall control and monitoring network, such as an industrial control network, and may include an application-specific computer, a general purpose computer, a programmable logic controller, or any other control and monitoring device. Moreover, system 28 may be linked to one or more sensors 32 and 34 for controlling the speed of the driven machine system 12, or even regulating the speed of the drive assembly 16 based upon a process parameter. For example, a closed-loop control scheme may be implemented to regulate speed of the drive assembly based upon such process parameters as flow rates, conveyer speeds, product production or transport speeds, temperatures, pressures, and so forth.

As noted above, the use of a high-speed motor 18 in the current implementation greatly facilitates significant reductions in the mass of the drive assembly 16, providing a high power density drive. The power density may be thought of as the ratio of the power available at the gear reducer output shaft divided by the weight or mass of the drive assembly. As noted in FIG. 1, where the drive assembly is mounted in the illustrated position, for example, a dimension 36 may be defined between the location of the assembly support structure and a point at which the high-speed motor is coupled to the gear reducer 20. This dimension represents the perpendicular distance at which the moment resulting from the weight of the motor is applied. The dimensions 38 and 40 illustrated in FIG. 1 represent the envelope dimensions for the motor frame. That is, as will be appreciated by those skilled in the art, the use of a high-speed motor 18 will result in significantly reduced envelope dimensions 38 and 40 as compared with similar dimensions of convention motors. Consequently, the reduced weight of the high-speed motor applied at the overhung load distance 36 represents significantly lower loading on both the gear reducer 20 and the machine frame on which the drive assembly 16 is mounted. The motor, then, may be up-rated for the same weight and load as compared to existing machines. Otherwise put, the weight and consequent mechanical load of the drive assembly is significantly reduced without sacrificing its power rating.

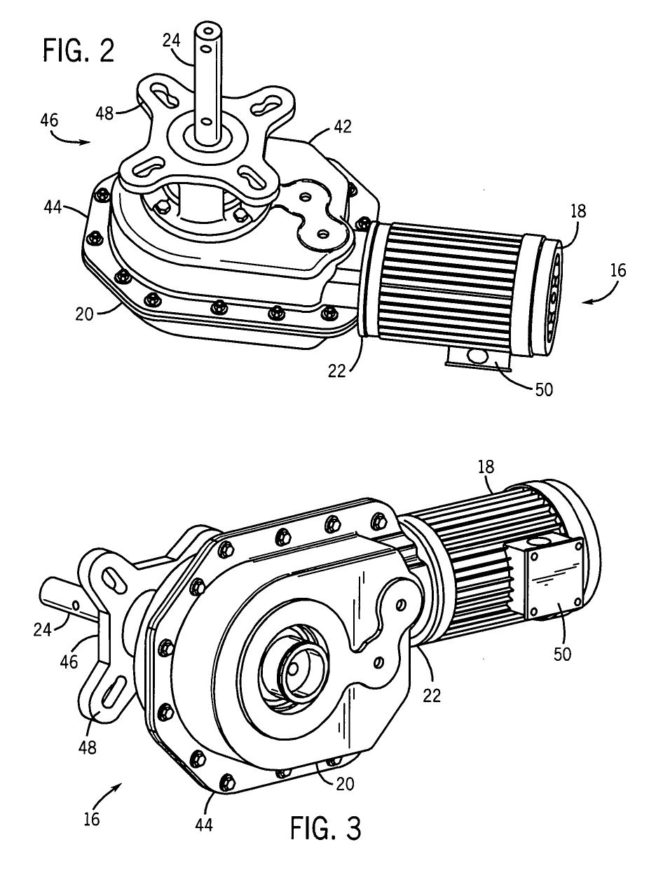

FIG. 2 represents an exemplary physical configuration of the drive assembly 16. In the view shown in FIG. 2, the gear reducer 20 has a frame or case 42 presenting a peripheral flange 44. The case 42 ultimately supports the high-speed motor 18. Here again, the use of a high-speed motor 18 thus permits a significantly reduced load to be applied to the case 42 of the gear reducer while maintaining a rated power for the overall drive assembly.

As also shown in FIG. 2, some type of machine mounting structure, designated generally by reference numeral 46 may be provided with the gear reducer. In the illustrated embodiment, the mounting structure includes a flange 48 designed to be bolted to a machine frame. Those skilled in the art will recognize that the drive assembly illustrated in FIG. 2 may be appropriate, for example, as a screw conveyer drive. However, other mounting structures and arrangements may be envisaged. For example, the same gear reducer may be employed as an overhung load mounted directly on a driven shaft. Moreover, other mounting structures may be envisaged, depending upon the nature and arrangement of the drive load, and the mounting surfaces and structures available for supporting the drive assembly.

Finally, motor 18 is provided with a junction box 50 for interconnecting the motor with the variable high-speed drive 26 described above with reference to FIG. 1.

FIG. 3 is a rear perspective view of the same drive assembly 16 illustrated in FIG. 2. Here again, the high-speed motor 18 is illustrated directly coupled to the gear reducer 20. The coupling 22 is illustrated and discussed in greater detail below. However, as will be appreciated by those skilled in the art, the coupling preferably permits the motor to be secured to and supported by the gear reducer. In a present implementation, the front face of the motor 18 presents a conventional C-face that can be interfaced with and supported on a corresponding receiving structure of the gear reducer 20. The mounting structure 46 here again includes a flange 48 for mounting on a machine frame. The output shaft 24 is driven by the gear reducer and applies rotational power to the driven load.

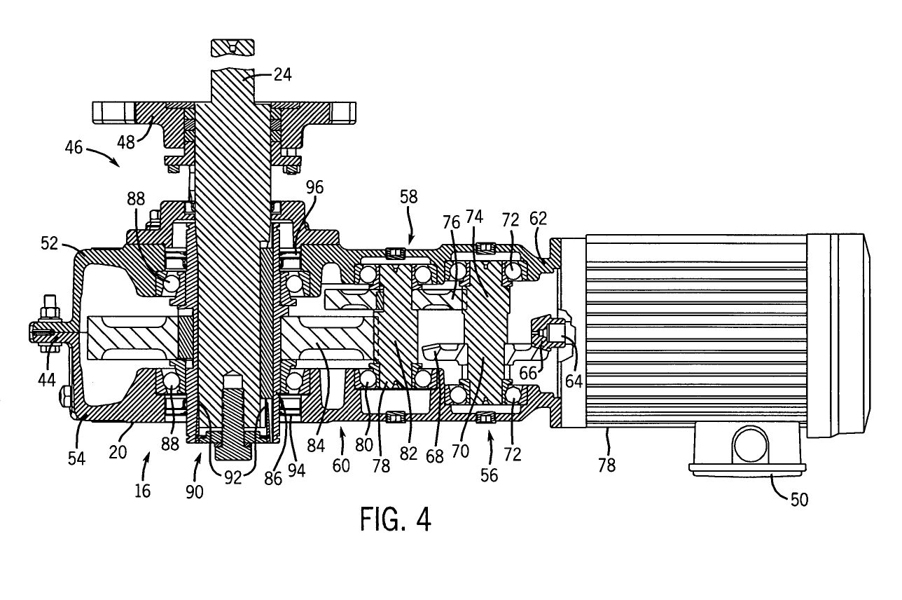

FIG. 4 is a partial sectional view of the gear reducer 20 and high-speed motor 18 making up the drive assembly 16. The gear reducer case 42 generally comprises a housing shell portion 52 that mates with a corresponding housing shell portion 54 to enclose an internal volume in which the rotating parts are supported and lubricated. The shell portions 52 and 54 are secured to one another via the peripheral flange 44 and appropriate bolt assemblies made up around the flange. While the gear reducer may include any appropriate number of reduction stages, in the illustrated embodiment, the reducer includes a first reduction stage 56 that is directly driven by the high-speed motor. A second reduction stage 58 is mechanically located downstream of the first reduction stage, and a third reduction stage 60 produces the output speed and torque. Each stage in the gear reduction will be described in greater detail below.

In a present implementation, the high-speed motor is directly secured to the case of the gear reducer 20 via an adapter face 62. The adapter face is machined to interface directly with the front face of the high-speed motor 18 to permit the motor to be bolted directly to the gear reducer. Alternatively, a separate adapter may be provided at this location. Motor 18 includes an output shaft or spindle 64 on which a bevel pinion 66 is mounted. The bevel pinion 66 engages a bevel gear 68 to drive a first shaft 70 in rotation. As will be appreciated by those skilled in the art, the provision of a fixed adapter face 62 which is machined to receive the high-speed motor 18 facilitates control of the engagement between the driving bevel pinion 66 and the bevel gear 68. Due to the high rotational speeds that can be attained by the high-speed motor 18, a reliable and controlled engagement between the bevel pinion and bevel gear is desired. The bevel pinion and bevel gear make up the first stage of gear reduction. The first shaft is mounted on suitable bearings 72 that are supported by the housing shell portions 52 and 54.

Shaft 70 includes a toothed portion 74 that engages a spur gear 76 making up the second stage of gear reduction. The gear 76 is supported on a second shaft 78 which, itself, is supported by bearings 80 in the housing shell portions 52 and 54.

Similarly, shaft 78 presents a toothed section 82 that engages an output spur gear. 84 to drive the output gear in rotation. The output gear 84 is mounted on a hub 86. The hub 86 is supported by bearings 88 in the housing shell portions 52 and 54.

As will be appreciated by those skilled in the art, the drive assembly illustrated in FIG. 4, particularly through the use of the output hub 86, defines a highly versatile structure that may be mounted directly on a machine shaft as an overhung load, or that may support an output shaft which is otherwise coupled to the driven load. That is, in the illustrated embodiment, the output shaft 24 is secured within hub 86 via an output shaft securement system 90. In the illustrated embodiment this system includes an inner taper at both ends of the hub 86. At an output end, the inner taper interfaces with an outer taper of the shaft 24. At an opposite end, the output shaft securement system 90 includes a coupling system 92 that drives a wedge-shaped ring between the inner taper of the hub and an outer surface of the shaft. Finally, seal systems 94 and 96 are provided to sealingly enclose the inner volume in which the rotating elements of the gear reducer are disposed. Where the drive assembly is to be mounted on a driven shaft as an overhung load, the driven shaft is secured within the hub 86 in the same manner as shaft 78.

In operation, the high-speed motor 18 is driven at variable speeds depending upon the desired driven (input) speed at the application. As noted above, the high-speed motor and its associated variable high-speed drive are designed to operate at speeds in excess of those available through conventional drive systems, which are commonly rated at synchronous speeds of 1800 and 3600 RPM. As also noted above, in the illustrated embodiment, the high-speed motor can attain speeds of 5400 RPM and beyond. Accordingly, the size and mass of the high-speed motor are significantly reduced for its power rating. The overall drive assembly, then, can be made less massive, accommodating applications in which space constraints, loading constraints and so forth are important design factors. More generally, the reduced drive assembly size and weight permit reduction in the size, rating and cost of all associated supports, bearings, and so forth.

Moreover, it has been found that driving the high speed motor 18 at higher speeds enhances cooling. Where a totally-enclosed, fan-cooled machine is employed, for example, the cooling fan included in the motor assembly aids in reducing added heat of the higher power delivered, adding to the ability to provide the higher power rating.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A high power density drive system comprising:
a gear reducer having a high-speed gear reducing input stage and an output element mechanically coupled to the high-speed gear reducing input stage, the high-speed input stage including an input pinion engaging a driven gear;
a high-speed electric motor coupled to the gear reducer and having an output shaft supporting the input pinion of the high-speed gear reducing input stage; and
a variable high-speed drive electrically coupled to the high-speed electric motor to drive the motor at variable speeds.

2. The system of claim 1, wherein the input pinion is a bevel pinion and the driven gear is a bevel gear mounted on an input stage shaft of the gear reducer.

3. The system of claim 1, wherein the high-speed electric motor at speeds in excess of 3600 RPM.

4. The system of claim 3, wherein the variable high-speed drive is configured to drive the high-speed electric motor at speeds of at least approximately 5400 RPM.

5. The system of claim 1, further comprising at least one sensor coupled to a machine system driven by the gear reducer, the variable high-speed drive applying drive signals to the high-speed electric motor to control an output speed of the gear reducer based upon a parameter sensed by the at least one sensor.

6. The system of claim 1, wherein the high-speed electric motor is mechanically supported directly on a frame of the gear reducer.

7. The system of claim 1, wherein the gear reducer includes three gear reduction stages including the high-speed input stage.

8. The system of claim 1, wherein the output element of the gear reducer is a hub, and the gear reducer and high-speed electric motor are configured to be supported as an overhung load via the hub.

9. A high power density drive system comprising:
a gear reducer having a high-speed gear reducing input stage and an output element mechanically coupled to the high-speed gear reducing input stage, the high-speed input stage including a bevel input pinion drivingly engaging a driven pinion gear; and
a high-speed electric motor supported on the gear reducer and having an output shaft supporting the input pinion of the high-speed gear reducing input stage, the high-speed electric motor being configured to drive the high-speed input stage at variable input speeds including continuous operating speeds in excess of 3600 RPM.

10. The system of claim 9, wherein the variable high-speed drive is configured to drive the high-speed electric motor at least approximately 5400 RPM.

11. The system of claim 9, wherein the high-speed electric motor is mechanically supported directly on a frame of the gear reducer.

12. The system of claim 9, wherein the gear reducer includes three gear reduction stages including the high-speed input stage.

13. The system of claim 9, wherein the output element of the gear reducer is a hub, and the gear reducer and high-speed electric motor are configured to be supported as an overhung load via the hub.

14. The system of claim 9, further comprising a support structure coupled to the gear reducer for supporting the gear reducer and high-speed electric motor on a machine frame.

15. A method for power transmission comprising:
coupling a drive assembly to a load, the drive assembly including a gear reducer having a high-speed gear reducing input stage and an output element mechanically coupled to the high-speed gear reducing input stage, the high-speed input stage including an input pinion engaging a driven gear, and a high-speed electric motor coupled to the gear reducer and having an output shaft supporting the input pinion of the high-speed gear reducing input stage; and
applying drive signals to the high-speed electric motor to drive the high-speed input stage at input speeds in excess of 3600 RPM.

16. The method of claim 15, comprising applying drive signals to the high-speed electric motor drive the input stage at variable input speeds of at least approximately 5400 RPM.

17. The method of claim 15, comprising supporting the drive assembly on a machine frame as an overhung load.

18. The method of claim 15, comprising sensing a parameter of a machine system driven by the drive assembly and controlling the speed of the high-speed electric motor based upon the sensed parameter.

19. The method of claim 18, wherein the sensed parameter is speed.

20. The method of claim 18, wherein the sensed parameter is a parameter of a process of which the load driven by the drive assembly is a part.
